(19) United States
(12) Patent Application Publication
(10) Pub. No.: US 2020/0161599 A1
(43) Pub. Date: May 21, 2020

(54) BATTERY CASE AND BATTERY

(71) Applicant: SAMSUNG ELECTRONICS CO., LTD., Suwon-si (KR)

(72) Inventors: Hyoungwoo CHOI, Hwaseong-si (KR); In Ki KIM, Hwaseong-si (KR); Feifei FANG, Suwon-si (KR); Joungeun YOO, Seongnam-si (KR); In Su LEE, Hwaseong-si (KR); Sung Dug KIM, Suwon-si (KR); In KIM, Suwon-si (KR)

(21) Appl. No.: 16/683,772

(22) Filed: Nov. 14, 2019

(30) Foreign Application Priority Data
Nov. 16, 2018 (KR) 10-2018-0141752

(51) Int. Cl. H01M 2/02; C09K 19/38; H01M 2/04

(52) U.S. Cl. CPC H01M 2/027; H01M 2/0267; H01M 2/0242; H01M 2/0478; C09K 19/3809

(57) ABSTRACT

A battery case including a container configured to accommodate an electrode assembly, wherein the container includes a bottom wall and a plurality of side walls, the bottom wall and the plurality of side walls are integrated to have an open side opposed to the bottom wall and to provide a space for accommodating the electrode assembly, wherein at least one of the bottom wall or the plurality of side walls includes a liquid crystal aromatic polymer, at least a portion of the liquid crystal aromatic polymer includes an aliphatic organic group at one terminal end, and the battery case has a WVTR at a thickness of about 1 mm at about 38° C. and a relative humidity of about 100% of less than about 0.07 g/m²/day and an impact strength of greater than or equal to about 20 KJ/m², a battery including the battery case, and a battery module.

### CROSS-REFERENCE TO RELATED APPLICATION

This application claims priority to Korean Patent Application No. 10-2018-0141752, filed on Nov. 16, 2018, and all the benefits accruing therefrom under 35 U.S.C. § 119, the content of which in its entirety is herein incorporated by reference.

### BACKGROUND

### 1. Field

This disclosure relates to a battery case and a battery including the battery case.

### 2. Description of the Related Art

As various types of mobile electronic devices and various types of electric powered transportation, e.g., electric powered passenger or commercial vehicles, are developed, research on a power source (e.g., a battery) for supplying devices and vehicles with electricity (or motive power) is of great interest and actively being pursued. The battery may be accommodated in a case and disposed individually or as a module in these devices or types of electric transportation. Accordingly, development of technology capable of improving properties of the battery case is of interest.

### SUMMARY

An embodiment provides a battery case having improved moisture transmission resistivity and impact strength.

Another embodiment provides a battery including the battery case.

In an embodiment, a battery case includes a container configured to accommodate an electrode assembly, wherein the container includes a bottom wall and a plurality of side walls, the bottom wall and the side walls are integrated to have an open side opposed to the bottom wall and to provide a space for accommodating the electrode assembly, wherein at least one of the bottom wall or the plurality of side walls includes a liquid crystal aromatic polymer, at least a portion of the liquid crystal aromatic polymer includes an aliphatic organic group at one terminal end, and the battery case has a water vapor transmittance rate (WVTR) at a thickness of about 1 millimeter (mm) according to ISO 15106 or ASTM F1249 at about 38° C. and a relative humidity of about 100% of less than about 0.07 grams per square meter per day (g/m²/day) and an impact strength according to ASTM D265 of greater than or equal to about 20 kiloJoules per square meter (KJ/m²).

The liquid crystal aromatic polymer may include liquid crystal aromatic polyester, liquid crystal aromatic polyamide, liquid crystal aromatic polyester amide, or a combination thereof.

The aliphatic organic group may be a substituted or unsubstituted C1 to C100 saturated or unsaturated aliphatic hydrocarbon group.

The liquid crystal aromatic polymer may include liquid crystal aromatic polyester and at least a portion of the liquid crystal aromatic polyester may include a substituted or unsubstituted C1 to C20 saturated or unsaturated aliphatic hydrocarbon group linked through an ester bond at one terminal end.

The liquid crystal aromatic polymer may include a liquid crystal aromatic polyamide and at least a portion of the liquid crystal aromatic polyamide may include a substituted or unsubstituted C1 to C20 saturated or unsaturated aliphatic hydrocarbon group linked through an amide bond at one terminal end.

The liquid crystal aromatic polymer may include a liquid crystal aromatic polyester amide and at least a portion of the liquid crystal aromatic polyester amide may include a substituted or unsubstituted C1 to C20 saturated or unsaturated aliphatic hydrocarbon group linked through an amide bond or an ester bond at one terminal end.

The liquid crystal aromatic polymer may include a structural unit represented by Chemical Formula 1 and/or a structural unit represented by Chemical Formula 2 and a structural unit represented by Chemical Formula 3:

*—(—(C═O)—Ar¹—O—)—* Chemical Formula 1

*—(—(O═O)—Ar²—(C═O)—)—* Chemical Formula 2

*—(—O—Ar³—O—)—* Chemical Formula 3

In Chemical Formulae 1 to 3,

Ar¹, Ar², and Ar³ are each independently a group including a substituted or unsubstituted C6 to C30 aromatic ring group, for example a substituted or unsubstituted C6 to C30 single aromatic ring group, a condensed ring of two or more substituted or unsubstituted C6 to C30 aromatic ring groups, or a group including two or more substituted or unsubstituted C6 to C30 aromatic ring groups that are linked by a single bond, —O—, —C(═O)—, —C(OH)₂—, —S—, or —S(O)₂—.

The liquid crystal aromatic polymer may include a structural unit represented by Chemical Formula 4 and/or a structural unit represented by Chemical Formula 5 and a structural unit represented by Chemical Formula 2. Accordingly, the liquid crystal aromatic polymer may include a structural unit represented by Chemical Formula 4, or a structural unit represented by Chemical Formula 5 and a structural unit represented by Chemical Formula 2. Another possibility is that, the liquid crystal aromatic polymer may include a structural unit represented by Chemical Formula 4, and a structural unit represented by Chemical Formula 5 and a structural unit represented by Chemical Formula 2.

*—(—(C═O)—Ar⁴—NH—)—* Chemical Formula 4

*—(—NH—Ar⁴—NH—)—* Chemical Formula 5

*—(—(C═O)—Ar²—(C═O)—)—* Chemical Formula 2

In Chemical Formula 4, Chemical Formula 5, and Chemical Formula 2,

Ar⁴, Ar⁵, and Ar² are each independently a group including a substituted or unsubstituted C6 to C30 aromatic ring group, for example a single substituted or unsubstituted C6 to C30 aromatic ring group, a condensed ring of two or more substituted or unsubstituted C6 to C30 aromatic ring groups, or a group including two or more substituted or unsubstituted C6 to C30 aromatic ring groups that are linked by a single bond, —O—, —C(═O)—, —C(OH)₂—, —S—, or —S(O)₂—.

The liquid crystal aromatic polymer may include

(1) (i) a structural unit represented by Chemical Formula 1 and/or a structural unit represented by Chemical Formula 2 and a structural unit represented by Chemical Formula 3, and (ii) a structural unit represented by Chemical Formula 4 and/or a structural unit represented by Chemical Formula 2 and a structural unit represented by Chemical Formula 5, and/or

(2) a structural unit represented by Chemical Formula 6 and a structural unit represented by Chemical Formula 2:

*—(—(C═O)—Ar¹—O—)—* Chemical Formula 1

*—(—(C═O)—Ar²—(C═O)—)—* Chemical Formula 2

*—(—O—Ar³—O—)—* Chemical Formula 3

*—(—(C═O)—Ar⁴—NH—)—* Chemical Formula 4

*—(—NH—Ar⁵—NH—)—* Chemical Formula 5

*—(—NH—Ar⁶—O—)—* Chemical Formula 6

In Chemical Formulae 1 to 6,

Ar¹ Ar², Ar³, Ar⁴, Ar⁵, and Ar⁶ are each independently a group including a substituted or unsubstituted C6 to C30 aromatic ring group, for example a single substituted or unsubstituted C6 to C30 aromatic ring group, a condensed ring of two or more substituted or unsubstituted C6 to C30 aromatic ring groups, or a group including two or more substituted or unsubstituted C6 to C30 aromatic ring groups that are linked by a single bond, —O—, —C(═O)—, —C(OH)₂—, —S—, or —S(O)₂—.

The structural unit represented by Chemical Formula 1 may be derived from p-hydroxybenzoic acid, 6-hydroxy-2-naphthoic acid, or a combination thereof.

The structural unit represented by Chemical Formula 2 may be derived from terephthalic acid, isophthalic acid, naphthalene dicarboxylic acid, or a combination thereof, and the structural unit represented by Chemical Formula 3 may be derived from hydroquinone, 4,4′-dihydroxybiphenyl, or a combination thereof.

The structural unit represented by Chemical Formula 4 may be derived from 4-aminobenzoic acid, 2-amino-naphthalene-6-carboxylic acid, 4-aminobiphenyl-4-carboxylic acid, or a combination thereof.

The structural unit represented by Chemical Formula 5 may be derived from 1,4-phenylene diamine, 1,3-phenylene diamine, 2,6-naphthalene diamine, or a combination thereof, and the structural unit represented by Chemical Formula 2 may be derived from terephthalic acid, isophthalic acid, naphthalene dicarboxylic acid, or a combination thereof.

The structural unit represented by Chemical Formula 6 may be derived from 3-aminophenol, 4-aminophenol, 2-amino-6-naphthol, or a combination thereof, and the structural unit represented by Chemical Formula 2 may be derived from terephthalic acid, isophthalic acid, naphthalene dicarboxylic acid, or a combination thereof.

The liquid crystal aromatic polymer may be a copolymer of about 60 mole percent (mol %) to about 80 mol % of p-hydroxybenzoic acid, about 20 mol % to about 40 mol % of 6-hydroxy-2-naphthoic acid, and less than or equal to about 20 mol % of a substituted or unsubstituted C1 to C20 monohydroxy alkane based on a total moles of the p-hydroxybenzoic acid and 6-hydroxy-2-naphthoic acid.

The battery case may further include a lid configured to cover at least a portion of the open side of the container, and have at least one of a positive terminal and a negative terminal.

The lid may include a liquid crystal aromatic polymer wherein at least a portion of the liquid crystal aromatic polymer has a substituted or unsubstituted aliphatic hydrocarbon group at one terminal end.

The container of the battery case may include a plurality of cell compartments defined by at least one partition wall, which can include a plurality of partition walls disposed in the space.

A battery according to another embodiment may include the battery case according to an embodiment and an electrode assembly including a positive electrode and a negative electrode accommodated in the container of the battery case.

A battery module according to another embodiment may include the battery case including the plurality of cell compartments and a plurality of electrode assemblies including a positive electrode and a negative electrode accommodated in each of the plurality of cell compartments of the battery case.

The battery case according to an embodiment may improve impact strength significantly while improving or maintaining barrier characteristics by including the aromatic liquid crystal polymer including the substituted or unsubstituted aliphatic hydrocarbon group at one terminal end. Therefore, the battery case according to an embodiment may be effectively used as a battery case of a rechargeable lithium battery requiring low water vapor transmittance and high impact resistance, and the like, and may be easily used in a desired size and shape by a known method such as injection molding. The battery case is advantageous for manufacturing a battery module, which is light in weight, strong in impact, capable of supplying a large capacity of power by accommodating a plurality of battery cells.

### BRIEF DESCRIPTION OF THE DRAWINGS

FIG. 1 is an exploded perspective view showing a battery case according to an embodiment.

FIG. 2 is an exploded perspective view showing a battery case according to another embodiment.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

Hereinafter, embodiments are described in detail. However, these embodiments are exemplary, the present disclosure is not limited thereto and the present disclosure is defined by the scope of claims.

If not defined otherwise, all terms (including technical and scientific terms) in the specification may be defined as commonly understood by one skilled in the art. The terms defined in a generally-used dictionary may not be interpreted ideally or exaggeratedly unless clearly defined. Accordingly, terms, such as those defined in commonly used dictionaries, should be interpreted as having a meaning that is consistent with their meaning in the context of the relevant art and the present disclosure, and will not be interpreted in an idealized or overly formal sense unless expressly so defined herein. In addition, unless explicitly described to the contrary, the word “comprise” and variations such as “comprises” or “comprising,” will be understood to imply the inclusion of stated elements but not the exclusion of any other elements.

Further, the singular includes the plural unless mentioned otherwise.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “At least one” is not to be construed as limiting “a” or “an.” “or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

In the drawings, the thickness of each element is exaggerated for better comprehension and ease of description. Like reference numerals designate like elements throughout the specification. It will be understood that when an element such as a layer, film, region, or plate is referred to as being “on” another element, it can be directly on the other element or intervening elements may also be present. In contrast, when an element is referred to as being “directly on” another element, there are no intervening elements present.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations. or within ±30%, 20%, 10% or 5% of the stated value.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Research on an electric vehicle (EV) using at least one battery system to supply a portion or all motive power is of great interest and actively being pursued. It can be expected that an electric vehicle discharges significantly less contamination material to the environment compared with a traditional vehicle operated by an internal combustion engine. Some electric vehicles using electricity use no gasoline at all or obtain entire motive power from electricity. As research on the electric vehicles is increases, demands for an improved power source for vehicles, for example, an improved battery module increases.

A rechargeable lithium battery capable of being charged and discharged and having high energy density can be an electrochemical device that includes a battery module for the electric vehicles. However, for a rechargeable lithium battery, when moisture permeates a battery exterior case, hydrofluoric acid (HF) is generated within the battery and can damage an electrode resulting in performance degradation of the battery. Presently, in order to minimize moisture from getting through the batter case, and hopefully to prevent or minimize performance degradation, an aluminum material having improved moisture transmission resistivity may be used as a case for a rechargeable lithium battery. That is, an electrode assembly including positive and negative electrodes is inserted into a case such as an aluminum pouch and sealed to make a battery cell. A plurality of the battery cells can be used to form a battery module. However, because this method can require a complicated assembly process, extended fabrication times, and be high cost, alternative integrated cases for battery cell-modules are of interest and are needed. Accordingly, research is underway to realize a battery cell-module integrated case without a need to construct a separate battery cell after manufacturing the electrode assembly. However, in order to realize such a cell-module integrated structure, performance parameters such as mechanical strength and moisture transmission resistivity also require technical consideration.

In addition, a battery case formed of a conventional metal is limited in shape due to a limit in terms of a metal manufacture technology, and a battery case having a desired shape or size requires a multistep process, a high cost, and a significant amount of production time. In addition, with a metal case of a large size, or with a plurality of containers to accommodate a plurality of battery cells, due to a weight of the metal itself, the case becomes very heavy and costs increase. Accordingly, commercial demands and requests for novel materials desirable for manufacturing a battery case and a battery using a battery case capable of solving a problem of heat management, moisture transmission, and the like, and having a low manufacturing cost and increased impact strength are described herein.

A liquid crystal polymer (LCP) is an engineering plastic having high heat resistance as an aromatic polyester made from an aromatic monomer. The liquid crystal polymer has rigid characteristics with a benzene ring and an ester group as a backbone and has an orientation in the injection direction through an injection process. Articles including liquid crystal polymers obtained by an injection process are superior to more common polymers in terms of tensile strength and moisture transmission resistivity, however impact characteristics (impact strength) of articles are somewhat low due to the rigid backbone structure.

As a compounding method to improve an impact strength of a liquid crystal polymer, an inorganic filler, an impact-reinforcing material, or the like, is added, or changing injection characteristics of materials has been researched. However, the methods require high temperature processes so that applicable materials and process conditions are extremely limited and there is a limit to performance improvement. Alternatively, the liquid crystal polymer may be copolymerized with a polymer other than liquid crystal polymer, such as PET (polyethylene terephthalate), PPT (polypropylene terephthalate), PTMT (polytrimethylene terephthalate), or PEN (polyethylene naphthalate), in order to improve mechanical properties of these polymers. However, articles made from such polymer materials do not meet the high mechanical properties or moisture transmission resistivity conditions required for application to electronic parts, such as battery container compartments and the like.

The present inventors have found that a flexible moiety introduced into the polymer to improve impact strength, as well as to maintain moisture transmission resistivity. In other words, adding a flexible aliphatic organic group-containing compound including a functional group having reactivity with aromatic monomers forming the liquid crystal polymer, and copolymerizing it with the aromatic monomers during the synthesis of the liquid crystal polymer provides a polymerization product including the liquid crystal polymer including a flexible aliphatic organic group at one terminal end. This liquid crystal polymer is then used to make an article exhibiting excellent moisture transmission resistivity and high impact strength. The liquid crystal polymer including a flexible aliphatic organic group at one terminal end has high heat resistance at a decomposition temperature of greater than or equal to about 350° C. and improved injection molding characteristics. Also, an article prepared from the liquid crystal polymer has high impact resistance and excellent moisture transmission resistivity despite a relatively low molecular weight. Accordingly, the liquid crystal polymer may be advantageously used to manufacture a battery case in which such properties are sought and in demand.

A battery case according to an embodiment includes a container configured to accommodate an electrode assembly. The container includes a bottom wall and a plurality of side walls, where the bottom wall and the plurality of side walls are integrated to have an open side opposed to the bottom wall, and to provide a space for accommodating the electrode assembly. At least one of the bottom wall or the plurality of side walls includes a liquid crystal aromatic polymer, where at least a portion of the liquid crystal aromatic polymer includes an aliphatic organic group at one terminal end. The battery case has a water vapor transmittance rate (WVTR) at a thickness of about 1 mm according to ISO 15106 or ASTM F1249 at about 38° C. and a relative humidity of about 100% of less than about 0.07 g/m²/day and an impact strength according to ASTM D265 of greater than or equal to about 20 KJ/m².

As noted, articles made from liquid crystal aromatic polymers and having an impact strength of greater than or equal to about 20 KJ/m² and a water vapor transmission rate (WVTR) of less than about 0.07 g/m²/day are not commonly, if at available. The battery case according to an embodiment has a high impact strength and excellent moisture transmission resistivity as described above, and therefore can replace present battery cases made of a metal.

The battery case according to an embodiment may have an impact strength measured according to ASTM D265 of greater than or equal to about 20 KJ/m², for example, greater than or equal to about 23 KJ/m², greater than or equal to about 25 KJ/m², greater than or equal to about 30 KJ/m², greater than or equal to about 35 KJ/m², greater than or equal to about 40 KJ/m², greater than or equal to about 45 KJ/m², greater than or equal to about 50 KJ/m², greater than or equal to about 55 KJ/m², greater than or equal to about 60 KJ/m², greater than or equal to about 65 KJ/m², greater than or equal to about 70 KJ/m², greater than or equal to about 75 KJ/m², greater than or equal to about 80 KJ/m², greater than or equal to about 85 KJ/m², greater than or equal to about 90 KJ/m², greater than or equal to about 95 KJ/m², greater than or equal to about 100 KJ/m², greater than or equal to about KJ/m², greater than or equal to about 110 KJ/m², greater than or equal to about 115 KJ/m², or greater than or equal to about 120 KJ/m², but is not limited thereto. This increased impact strength is significantly improved, and is not easily achieved with articles made from aromatic liquid crystal polymers wherein at least a portion of the polymer do not include a flexible aliphatic organic group at one terminal end as described herein.

The battery case according to an embodiment may have a water vapor transmittance rate (WVTR) according to ISO 15106 or ASTM F1249 at about 38° C. and a relative humidity of about 100% of less than about 0.07 g/m²/day, for example, less than or equal to about 0.06 g/m²/day, less than or equal to about 0.05 g/m²/day, less than or equal to about 0.04 g/m²/day, less than or equal to about 0.03 g/m²/day, less than or equal to about 0.025 g/m²/day, less than or equal to about 0.023 g/m²/day, less than or equal to about 0.020 g/m²/day, less than or equal to about 0.017 g/m²/day, less than or equal to about 0.015 g/m²/day, less than or equal to about 0.010 g/m²/day, less than or equal to about 0.009 g/m²/day, less than or equal to about 0.0085 g/m²/day, less than or equal to about 0.0080 g/m²/day, less than or equal to about 0.0075 g/m²/day, less than or equal to about 0.0070 g/m²/day, less than or equal to about 0.0065 g/m²/day, less than or equal to about 0.0060 g/m²/day, or less than or equal to about 0.0055 g/m²/day, but is not limited thereto.

In the battery case according to an embodiment, by adjusting types of the liquid crystal aromatic polymer, types and amounts of monomers providing the liquid crystal aromatic polymer, a molecular weight of the liquid crystal aromatic polymer, and types and amounts of other components for molding the battery case, the moisture transmission resistivity and impact strength within the indicated ranges may be adjusted to the desired ranges.

The battery case according to an embodiment may be manufactured using various types of liquid crystal aromatic polymers known in the art. The liquid crystal aromatic polymer may be, for example, liquid crystal aromatic polyester, liquid crystal aromatic polyamide, liquid crystal aromatic polyesteramide, or a combination thereof.

In the battery case according to an embodiment, the aliphatic organic group bonded at one terminal end of at least a portion of the liquid crystal aromatic polymer may be a substituted or unsubstituted C1 to C100 saturated or unsaturated aliphatic hydrocarbon group. For example, the aliphatic organic group may be a substituted or unsubstituted C1 to C20 saturated or unsaturated aliphatic hydrocarbon group, and, for example, the aliphatic organic group may be a substituted or unsubstituted C1 to 010 saturated or unsaturated aliphatic hydrocarbon group, for example, a substituted or unsubstituted C1 to 010 saturated aliphatic hydrocarbon group.

In an embodiment, the liquid crystal aromatic polymer may include a liquid crystal aromatic polyester and the liquid crystal aromatic polyester may include a structural unit represented by Chemical Formula 1 and/or a structural unit represented by Chemical Formula 2 and a structural unit represented by Chemical Formula 3:

*—(—(C═O)—Ar¹—O—)—* Chemical Formula 1

*—(—C═O)—Ar²—(C═O)—)—* Chemical Formula 2

*—(—O—Ar³—O—)—* Chemical Formula 3

In Chemical Formulae 1 to 3,

Ar¹, Ar², and Ar³ are each independently a group including a substituted or unsubstituted C6 to C30 aromatic ring group. For example, Ar¹, Ar², and Ar³ are each independently a single substituted or unsubstituted C6 to C30 aromatic cyclic group, a condensed ring of two or more substituted or unsubstituted C6 to C30 aromatic cyclic groups, or a group including two or more substituted or unsubstituted C6 to C30 aromatic ring groups that are linked by a single bond, —O—, —C(═O)—, —C(OH)₂—, —S—, or —S(O)₂—.

In an embodiment, Ar¹, Ar², and Ar³ of Chemical Formula 1 to 3 may each independently be a substituted or unsubstituted phenylene group, a substituted or unsubstituted biphenylene group, a substituted or unsubstituted naphthalenylene group, a substituted or unsubstituted anthracenylene group, a substituted or unsubstituted phenanthrenylene group, a substituted or unsubstituted naphthacenylene group, a substituted or unsubstituted pyrenylene group, and the like, and for example, a phenylene group, a biphenylene group, or a naphthalenylene group, but are not limited thereto.

The structural unit represented by Chemical Formula 1 may be derived from an aromatic hydroxycarboxylic acid, and the aromatic hydroxycarboxylic acid may be at least one of 4-hydroxybenzoic acid, glycolic acid, 6-hydroxy-2-naphthoic acid, 6-hydroxy-1-naphthoic acid, 3-methyl-4-hydroxybenzoic acid, 3,5-dimethyl-4-hydroxybenzoic acid, 2,6-dimethyl-4-hydroxybenzoic acid, 3-methoxy-4-hydroxybenzoic acid, 3,5-dimethoxy-4-hydroxybenzoic acid, 6-hydroxy-5-methyl-2-naphthoic acid, 6-hydroxy-5-methoxy-2-naphthoic acid, 2-chloro-4-hydroxybenzoic acid, 3-chloro-4-hydroxybenzoic acid, 2,3-dichloro-4-hydroxybenzoic acid, 3,5-dichloro-4-hydroxybenzoic acid, 2,5-dichloro-4-hydroxybenzoic acid, 3-bromo-4-hydroxybenzoic acid, 6-hydroxy-5-chloro-2-naphthoic acid, 6-hydroxy-7-chloro-2-naphthoic acid, 6-hydroxy-5,7-dichloro-2-naphthoic acid, or p-β-hydroxyethoxybenzoic acid, for example, 4-hydroxybenzoic acid and/or 6-hydroxy-2-naphthoic acid, but is not limited thereto.

The structural unit represented by Chemical Formula 2 may be derived from aromatic dicarboxylic acid, and the aromatic dicarboxylic acid may be at least one of terephthalic acid, 4,4′-biphenyldicarboxylic acid, 4,4′-terphenyldicarboxylic acid, 1,6-naphthalene dicarboxylic acid, 2,6-naphthalene dicarboxylic acid, 1,4-naphthalene dicarboxylic acid, 2,7-naphthalene to dicarboxylic acid, diphenyl ether-4,4′-dicarboxylic acid, diphenoxyethane-4,4′-dicarboxylic acid, diphenoxy butane-4,4′-dicarboxylic acid, diphenyl ethane-4,4′-dicarboxylic acid, isophthalic acid, diphenyl ether-3,3′-dicarboxylic acid, diphenoxyethane-3,3′-dicarboxylic acid, diphenyl ethane-3,3′-dicarboxylic acid, chloro terephthalic acid, dichloroterephthalic acid, dichloroisophthalic acid, bromo terephthalic acid, methylterephthalic acid, dimethylterephthalic acid, ethyl terephthalic acid, methoxy terephthalic acid, or ethoxyterephthalic acid, for example, terephthalic acid, isophthalic acid, naphthalene dicarboxylic acid, or a combination thereof, but is not limited thereto.

The structural unit represented by Chemical Formula 3 may be derived from aromatic diol, and the aromatic diol may be at least one of catechol, resorcinol, hydroquinone, 4,4′-dihydroxybiphenyl, 2,2-bis(4′-β-hydroxyethoxyphenyl) propane, bis(4-hydroxyphenyl) sulfone, bis(4-β-hydroxyethoxyphenyl) sulfonic acid, 9,9′-bis(4-hydroxyphenyl) fluorene, 3,3′-dihydroxybiphenyl, 4,4′-dihydroxyterphenyl, 2,6-naphthalenediol, 4,4′-dihydroxydiphenyl ether, bis(4-hydroxyphenoxy) ethane, 3,3′-dihydroxydiphenyl ether, 1,6-naphthalenediol, 2,2-bis(4-hydroxyphenyl) propane, bis(4-hydroxyphenyl) methane, chloro hydroquinone, methylhydroquinone, tert-butyl hydroquinone, phenyl hydroquinone, methoxy hydroquinone, phenoxyhydroquinone, 4-chloro resorcinol, or 4-methyl resorcinol, for example, hydroquinone, 4,4′-dihydroxybiphenyl, or a combination thereof, but is not limited thereto.

When the battery case according to an embodiment includes a liquid crystal aromatic polyester and at least a portion of the liquid crystal aromatic polyester includes the aliphatic organic group at one terminal end, the aliphatic organic group may be linked with the liquid crystal aromatic polyester with an ester bond. Herein, the aliphatic organic group may be derived from a compound having a reactive group, for example, a hydroxy group which may form an ester bond with a carboxyl group of an aromatic monomer forming the liquid crystal aromatic polyester. For example, the aliphatic organic group may be derived from substituted or unsubstituted C1 to C20 aliphatic primary alcohol having a hydroxy group at one terminal end. For example, the substituted or unsubstituted C1 to C20 aliphatic primary alcohol may be a substituted or unsubstituted C1 to 010 aliphatic primary alcohol, for example, a substituted or unsubstituted methanol, a substituted or unsubstituted ethanol, a substituted or unsubstituted propanol, a substituted or unsubstituted butanol, a substituted or unsubstituted pentenol, a substituted or unsubstituted hexanol, a substituted or unsubstituted heptanol, a substituted or unsubstituted octanol, a substituted or unsubstituted nonanol, a substituted or unsubstituted decanol, or a combination thereof, and for example, the substituted or unsubstituted C1 to 010 aliphatic primary alcohol may be a substituted or unsubstituted decanol.

The compound including the hydroxy group and the aliphatic organic group may be substituted with any chemical stable element or functional group as long as the element does not impair flexibility of the aliphatic organic group, does not react with the aromatic monomer forming the liquid crystal aromatic polymer, and does not decompose during the process and thereby impair formability of the liquid crystal aromatic polymer. For example, the compound may be substituted with a halogen atom, for example, a fluorine atom.

In an embodiment, the liquid crystal aromatic polymer may include a liquid crystal aromatic polyamide and the liquid crystal aromatic polyamide may include a structural unit represented by Chemical Formula 4 and/or a structural unit represented by Chemical Formula 5 and a structural unit represented by Chemical Formula 2:

*—(—(C═O)—Ar⁴—NH—)—* Chemical Formula 4

*—(—NH—Ar⁴—NH—)—* Chemical Formula 5

*—(—(C═O)—Ar²—(C═O)—)—* Chemical Formula 2

In Chemical Formula 4, Chemical Formula 5, and Chemical Formula 2, Ar⁴, Ar⁵, and Ar² may each independently be a group including a substituted or unsubstituted C6 to C30 aromatic ring group. For example, Ar⁴, Ar⁵, and Ar² may each independently be a single substituted or unsubstituted C6 to C30 aromatic ring group, a condensed ring of two or more substituted or unsubstituted C6 to C30 aromatic ring groups, or a group including two or more substituted or unsubstituted C6 to C30 aromatic ring groups that are linked by a single bond, —O—, —C(═O)—, —C(OH)₂—, —S—, or —S(O)₂—.

For example, Ar⁴, Ar⁵, and Ar² of Chemical Formulae 2, 4, and 5 may each independently be a substituted or unsubstituted phenylene group, a substituted or unsubstituted biphenylene group, a substituted or unsubstituted naphthalenylene group, a substituted or unsubstituted anthracenylene group, a substituted or unsubstituted phenanthrenylene group, a substituted or unsubstituted naphthacenylene group, a substituted or unsubstituted pyrenylene group, and the like, for example, a phenylene group, a biphenylene group, or a naphthalenylene group, but are not limited thereto.

The structural unit represented by Chemical Formula 4 may be derived from aromatic aminocarboxylic acid, and the aromatic aminocarboxylic acid may be for example, 4-aminobenzoic acid, 2-amino-naphthalene-6-carboxylic acid, 4-aminobiphenyl-4-carboxylic acid, or a combination thereof, but is not limited thereto.

The structural unit represented by Chemical Formula 5 may be derived from aromatic diamine, and the aromatic diamine may be at least one of 1,4-phenylene diamine, 1,3-phenylene diamine, 2,6-naphthalene diamine, N,N,N′,N′-tetramethyl-1,4-diaminobenzene, N,N,N′,N′-tetramethyl-1,3-diaminobenzene, 1,8-bis(dimethylamino)naphthalene, or 4,5-bis(dimethylamino) fluorene, for example, 1,4-phenylene diamine, 1,3-phenylene diamine, 2,6-naphthalene diamine, or a combination thereof, but is not limited thereto.

The structural unit represented by Chemical Formula 2 may be derived from the aforementioned aromatic dicarboxylic acid, and the aromatic dicarboxylic acid may be, for example, terephthalic acid, isophthalic acid, naphthalene dicarboxylic acid, or a combination thereof.

When the battery case according to an embodiment includes a liquid crystal aromatic polyamide, and at least a portion of the liquid crystal aromatic polyamide includes the aliphatic organic group at one terminal end, the aliphatic organic group may be linked with the liquid crystal aromatic polyamide with an amide bond. Herein, the aliphatic organic group may be derived from a compound having a reactive group, for example, an amino group which may form an amide bond with a carboxyl group of an aromatic monomer forming the liquid crystal aromatic polyamide. For example, the aliphatic organic group may be derived from substituted or unsubstituted C1 to C20 aliphatic primary amine having an amino group at one terminal end. For example, the substituted or unsubstituted C1 to C20 aliphatic primary amine may be a substituted or unsubstituted C1 to C10 aliphatic primary amine, for example, a substituted or unsubstituted methylamine, a substituted or unsubstituted ethylamine, a substituted or unsubstituted propylamine, a substituted or unsubstituted butylamine, a substituted or unsubstituted pentylamine, a substituted or unsubstituted hexylamine, a substituted or unsubstituted heptylamine, a substituted or unsubstituted octylamine, a substituted or unsubstituted nonylamine, a substituted or unsubstituted decylamine, or a combination thereof, and for example, the substituted or unsubstituted C1 to C10 aliphatic primary amine may be a substituted or unsubstituted decylamine. The substitution of the aliphatic organic group is the same as described above.

In an embodiment, the liquid crystal aromatic polymer may include liquid crystal aromatic polyester amide, and the liquid crystal aromatic polyester amide may include

(1) (i) a structural unit forming a liquid crystal aromatic polyester including a structural unit represented by Chemical Formula 1 and/or a structural unit represented by Chemical Formula 2 and a structural unit represented by Chemical Formula 3, and (ii) a structural unit forming a liquid crystal aromatic polyamide including a structural unit represented by Chemical Formula 4, a structural unit represented by Chemical Formula 2, and/or a structural unit represented by Chemical Formula 5, and/or

(2) a structural unit forming liquid crystal aromatic polyester amide including a structural unit represented by Chemical Formula 6 and a structural unit represented by Chemical Formula 2:

*—(—(C═O)—Ar¹—O—)—* Chemical Formula 1

*—(—(C═O)—Ar²—(C═O)—)—* Chemical Formula 2

*—(—O—Ar³—O—)—* Chemical Formula 3

*—(—(C═O)—Ar⁴—NH—)—* Chemical Formula 4

*—(—NH—Ar⁵—NH—)—* Chemical Formula 5

*—(—NH—Ar⁶—O—)—* Chemical Formula 6

### In Chemical Formulae 1 to 6,

Ar¹, Ar², Ar³, Ar⁴, Ar⁵, and Ar⁶ may each independently be a group including a substituted or unsubstituted C6 to C30 aromatic ring group. For example, Ar¹, Ar², Ar³, Ar⁴, Ar⁵, and Ar⁶ may each independently be a single substituted or unsubstituted C6 to C30 aromatic cyclic group, a condensed ring system including two or more substituted or unsubstituted C6 to C30 aromatic cyclic groups, or a group including two or more substituted or unsubstituted C6 to C30 aromatic cyclic groups that are linked by a single bond, —O—, —C(═O)—, —C(OH)₂—, —S—, or —S(O)₂—.

For example, Ar¹, Ar², Ar³, Ar⁴, Ar⁵, and Ar⁶ of Chemical Formulae 1 to 6 may each independently be a substituted or unsubstituted phenylene group, a substituted or unsubstituted biphenylene group, a substituted or unsubstituted naphthalenylene group, a substituted or unsubstituted anthracenylene group, a substituted or unsubstituted phenanthrenylene group, a substituted or unsubstituted naphthacenylene group, a substituted or unsubstituted pyrenylene group, and the like, for example, a phenylene group, a biphenylene group, or a naphthalenylene group, but are not limited thereto.

The structural units represented by Chemical Formula 1 to Chemical Formula 5 are the same as described above, and thus detailed description thereof will be omitted.

The structural unit represented by Chemical Formula 6 may be derived from aromatic hydroxy amine, and the aromatic hydroxy amine may be, for example, 3-aminophenol, 4-aminophenol, 2-amino-6-naphthol, or a combination thereof but is not limited thereto.

When the battery case according to an embodiment includes a liquid crystal aromatic polyester amide and at least a portion of the liquid crystal aromatic polyester amide includes the aliphatic organic group at one terminal end, the aliphatic organic group may be linked with the liquid crystal aromatic polyester amide with an ester bond and/or an amide bond. Herein, the aliphatic organic group may be derived from a compound having a reactive group, for example, a hydroxy group which may form an ester bond with a carboxyl group of an aromatic monomer forming the liquid crystal aromatic polyester, or a compound having a reactive group, for example, an amino group which may form an amide bond with a carboxyl group of an aromatic monomer forming the liquid crystal aromatic polyamide. For example, the aliphatic organic group may be derived from substituted or unsubstituted C1 to C20 aliphatic primary alcohol having a hydroxy group at one terminal end and/or substituted or unsubstituted C1 to C20 aliphatic primary amine having an amino group at one terminal end. The substituted or unsubstituted C1 to C20 aliphatic primary alcohol and/or the substituted or unsubstituted C1 to C20 aliphatic primary amine are the same as described above.

In an embodiment, the liquid crystal aromatic polymer forming the battery case may include liquid crystal aromatic polyester produced by copolymerization of p-hydroxybenzoic acid and 6-hydroxy-2-naphthoic acid, and at least a portion of the liquid crystal aromatic polyester may include a substituted or unsubstituted C1 to C20 aliphatic organic group, for example, a saturated or unsaturated hydrocarbon group linked through an ester bond at one terminal end linked.

In an embodiment, the liquid crystal aromatic polyester may be a copolymer of about 55 mole percent (mol %) to about 85 mol % of p-hydroxybenzoic acid, about 15 mol % to about 45 mol % of 6-hydroxy-2-naphthoic acid, and less than or equal to about 20 mol % of a substituted or unsubstituted C1 to C20 monohydroxy alkane based on a total moles of the p-hydroxybenzoic acid and 6-hydroxy-2-naphthoic acid.

For example, the liquid crystal aromatic polyester may be a copolymer of about 60 mol % to about 80 mol % of p-hydroxybenzoic acid and about 20 mol % to about 40 mol % of 6-hydroxy-2-naphthoic acid, for example, about 65 mol % to about 80 mol % of p-hydroxybenzoic acid and about 20 mol % to about 35 mol % of 6-hydroxy-2-naphthoic acid, about 65 mol % to about 75 mol % of p-hydroxybenzoic acid and about 25 mol % to about 35 mol % of 6-hydroxy-2-naphthoic acid, or about 70 mol % to about 75 mol % of p-hydroxybenzoic acid and about 25 mol % to about 30 mol % of 6-hydroxy-2-naphthoic acid, and a substituted or unsubstituted C1 to C20 monohydroxy alkane in an amount of less than or equal to about 20 mol %, about 1 mol % to about 19 mol %, about 1 mol % to about 17 mol %, about 1 mol % to about 15 mol %, about 1.5 mol % to about 17 mol %, about 1.5 mol % to about 15 mol %, about 2 mol % to about 17 mol %, about 2 mol % to about 15 mol %, about 2 mol % to about 13 mol %, about 2 mol % to about 10 mol %, about 2.5 mol % to about 17 mol %, about 2.5 mol % to about 15 mol %, about 2.5 mol % to about 13 mol %, about 2.5 mol % to about 10 mol %, about 2.5 mol % to about 9 mol %, about 2.5 mol % to about 8.5 mol %, about 2.5 mol % to about 8 mol %, about 2.5 mol % to about 7.5 mol %, about 2.5 mol % to about 7 mol %, about 2.5 mol % to about 6.5 mol %, about 2.5 mol % to about 6 mol %, or about 2.5 mol % to about 5.5 mol % based on a total moles of the p-hydroxybenzoic acid and 6-hydroxy-2-naphthoic acid, but is not limited thereto.

The liquid crystal aromatic polymer including a substituted or unsubstituted aliphatic organic group linked through an ester bond or an amide bond at one terminal end may be synthesized by adding and reacting a substituted or unsubstituted aliphatic organic group-containing compound having a reactive group capable of forming the ester bond or the amide bond with the aromatic monomers, for example, a substituted or unsubstituted saturated or unsaturated aliphatic hydrocarbon compound having a hydroxy group or an amino group at one terminal end, for example, a substituted or unsubstituted aliphatic primary alcohol and/or a substituted or unsubstituted aliphatic primary amine, from the beginning during the acetylation and condensation polymerization of the aromatic monomers for synthesizing the liquid crystal aromatic polymer. For example, in an embodiment, when the liquid crystal aromatic polymer includes a liquid crystal aromatic polyester prepared by copolymerizing p-hydroxybenzoic acid and 6-hydroxy-2-naphthoic acid, the p-hydroxybenzoic acid, the 6-hydroxy-2-naphthoic acid, and a substituted or unsubstituted aliphatic primary alcohol, for example, decanol, in each predetermined amount are placed in a reactor, acetic anhydride is added thereto, a temperature is increased up to about 140° C. and maintained for a predetermined time to acetylate an aromatic monomer and a hydroxy terminal end of the aliphatic primary alcohol, and then, the temperature is slowly increased up to 320° C. to react them and thus obtain a polymerization product including the liquid crystal aromatic polyester prepared by copolymerizing the p-hydroxybenzoic acid and the 6-hydroxy-2-naphthoic acid, wherein at least a portion of the liquid crystal aromatic polyester includes a decyl group linked through an ester bond with the decanol. This polymerization product is injection-molded to obtain a battery case according to an embodiment.

The obtained polymerization product has a mass loss of less than or equal to about 1 percent (%) at a temperature of less than or equal to about 400° C. and is very stable, and in addition, since the polymerization product includes a flexible aliphatic organic group, viscosity of reactants including the polymerization product is decreased, and thus, a liquid crystal aromatic polymer having a higher molecular weight may easily be prepared, and processability may be improved. An article, such as, for example, a battery case and the like, manufactured from the liquid crystal aromatic polymer having a higher molecular weight may have a higher heat resistance, better mechanical properties, for example, a higher impact strength, and also, much improved moisture transmission resistivity.

In an embodiment, the battery case has a bottom wall and a plurality of side walls forming the container, of which at least one may include the above-described liquid crystal aromatic polymer. For example, all of the bottom wall and the plurality of side walls may include the above-described liquid crystal aromatic polymer. In addition, herein, at least one of the bottom wall or the plurality of side walls, or both of the bottom wall and the plurality of side walls may include an article manufactured from the liquid crystal aromatic polymer. The container is formed by integrating the bottom wall and the plurality of side walls, wherein “integrating” refers to a combination of the bottom wall with the plurality of side walls to form one shape, or refers to connection of the bottom wall with the plurality of side walls except the open side to form a closed shape. The integrating method is not particularly limited, and for example, as described later, the liquid crystal aromatic polymer is molded in a form of a container having the bottom wall and the plurality of side walls in one step, or is molded into separate articles of the bottom wall and the plurality of side walls and then they are connected by known methods of welding or adhering to form an integrated shape.

As described above, since the battery case according to an embodiment has greatly improved moisture transmission resistivity and mechanical strength, which may not be accomplished by a conventional plastic-based article including a publicly-known plastic or liquid crystal polymer, an electrode assembly including positive and negative electrodes may be directly inserted therein to form a battery without being wrapped with an additional exterior material, such as a metal pouch, and the battery case manufactured in this way has improved durability. Conventionally, an electrode assembly including positive and negative electrodes is formed and then wrapped with a metal pouch having moisture transmission resistivity to form a battery cell, and then, packed in a metallic battery case having a battery cell container to manufacture a battery or a battery module, which is complicated in terms of a process, takes a long time, and with increasingly high costs.

As described above, the battery case according to an embodiment may have greatly improved moisture transmission resistivity and mechanical strength, since a bottom wall and at least one of a plurality of side walls forming the container, for example, both the bottom wall and a plurality of side walls include an article including the liquid crystal aromatic polymer as described herein. The battery case may be kept sealed by covering and sealing an open side of the container of the battery case with a lid covering at least a portion of the open side, for example, a whole side of the open side. The lid may also be manufactured from an article including the liquid crystal aromatic polymer which forms the container of the battery case. The lid may include at least one of a positive terminal and a negative terminal.

A method of producing an article is not particularly limited and may be appropriately selected. For example, the article may be obtained by molding a composition including the liquid crystal aromatic polymer to obtain a pellet and molding the pellet to have a desired shape through an extrusion molding machine or an injection molding machine. Types of the extrusion molding machine and the injection molding machine are not particularly limited but may be publicly known in the related art. This extrusion molding machine or injection molding machine is commercially available. In addition, the molding method may include publicly-known various methods, such as, for example, extrusion molding, injection molding, blow molding, press molding, and the like, to obtain a desired size and shape.

Hereinafter, a battery case according to an embodiment is described with reference to the appended drawings.

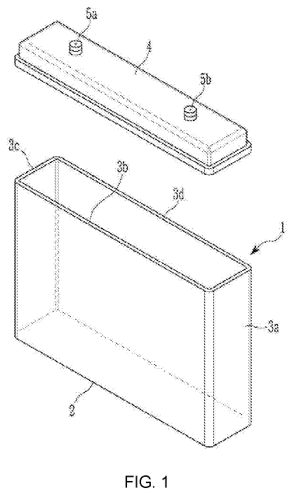

FIG. 1 is an exploded perspective view showing a battery case according to an embodiment.

Referring to FIG. 1, a battery case according to an embodiment includes a container 1 including a bottom wall 2 and a plurality of (e.g., 3, 4, or greater) side walls 3a, 3b, 3c, and 3d that are integrated to provide a space for accommodating an electrode assembly. The container 1 has an open side opposed to the bottom wall 2 and an electrode assembly may be accommodated in the container 1 through the open side 2. The battery case may further include a lid 4 to cover (e.g., seal) at least a portion, for example, a whole of the open side of the container 1. The lid 4 may have at least one of the positive terminal 5a and the negative terminal 5b (e.g., positive terminal and negative terminal). The lid 4 may include the same material as the container 1 or a different material from the container 1.

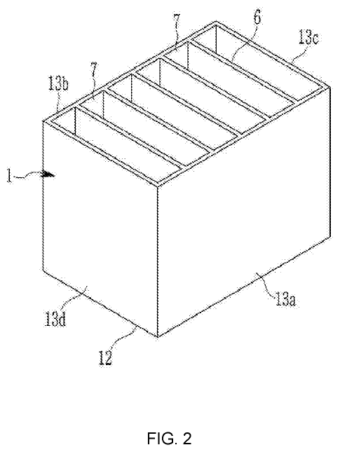

FIG. 2 is an exploded perspective view of a battery case according to another embodiment.

Referring to FIG. 2, a container 1 of a battery case according to an embodiment has a space formed by integrating a bottom wall 12 with a plurality of side walls 13a, 13b, 13c, and 13d, and in the space, at least one, for example 2, 3, 4, 5, or more partition walls 6 may be provided. The space in the container 1 may include a plurality of 2 or more, for example, 3 or more, for example, 4 or more, or 5 or more battery cell compartments 7 by the partition wall 6. Each battery cell compartment 7 may include an electrode assembly including a positive electrode and a negative electrode that will be described below.

FIGS. 1 and 2 show a rectangular parallelepiped battery case, but the battery case according to an embodiment has no limit to the shape but may have various shapes and sizes and the various numbers of containers and cell compartments.

A battery or a battery module according to an embodiment may be manufactured by accommodating an electrode assembly including positive and negative electrodes in the container 1 of the battery case in FIG. 1 or respectively in a plurality of cell compartments 7 in the container 1 in FIG. 2. This battery or battery module is manufactured by accommodating the electrode assembly in the container 1 or respectively in the cell compartments 7 of the battery case in FIG. 1 or 2, and then, injecting an electrolyte solution into the container 1 or the cell compartments 7 to supply the electrode assembly with the electrolyte solution. After injecting the electrolyte solution into the container 1 or the cell compartment 7 in which the electrode assembly is disposed, an open side of each battery case is closed or sealed with the lid 4 to manufacture the battery or battery module according to an embodiment.

Hereinafter, the electrode assembly is described.

The electrode assembly includes a positive electrode, a negative electrode, and a separator disposed therebetween. The electrode assembly may further include, for example an aqueous non-aqueous electrolyte solution in the separator. The types of the electrode assembly are not particularly limited. In an embodiment, the electrode assembly may include an electrode assembly for a rechargeable lithium battery. The positive electrode, the negative electrode, the separator, and the electrolyte solution of the electrode assembly may be appropriately selected according to types of the electrode and are not particularly limited. Hereinafter, the electrode assembly for a rechargeable lithium battery is exemplified but the present disclosure is not limited thereto.

The positive electrode may include, for example, a positive active material disposed on a positive current collector and may further include at least one of a conductive material and a binder. The positive electrode may further include a filler. The negative electrode may include, for example a negative active material disposed on a negative current collector and may further include at least one of a conductive material and a binder. The negative electrode may further include a filler.

The positive active material may include, for example a (solid solution) oxide including lithium but is not particularly limited as long as it is a material capable of intercalating and de-intercalating lithium ions electrochemically. The positive active material may be a layered compound such as lithium cobalt oxide (LiCoO₂), lithium nickel oxide (LiNiO₂), and the like, a compound substituted with one or more transition metal; a lithium manganese oxide such as Chemical Formula Li₁₊ₓMn₂₋ₓO₄ (wherein, x is 0 to 0.33), LiMnO₃, LiMn₂O₃, LiMnO₂, and the like; lithium copper oxide (Li₂CuO₂); vanadium oxide such as LiV₃O₈, LiFe₃O₄, V₂O₅, Cu₂V₂O₇, and the like; a Ni site-type lithium nickel oxide represented by Chemical Formula LiNi₁₋ₓMₓO₂ (wherein, M=Co, Mn, Al, Cu, Fe, Mg, B, or Ga, and x=0.01 to 0.3); a lithium manganese composite oxide represented by Chemical Formula LiMn₂₋ₓMₓO₂ (wherein, M=Co, Ni, Fe, Cr, Zn, or Ta, and x=0.01 to 0.1) or Li₂Mn₃MO₈ (wherein, M=Fe, Co, Ni, Cu, or Zn); LiMn₂O₄ where a portion of Li of Chemical Formula is substituted with an alkaline-earth metal ion; a disulfide compound; Fe₂(MoO₄)₃, and the like, but is not limited thereto.

Examples of the conductive material may be carbon black, such as, for example, ketjen black, acetylene black, and the like, natural graphite, artificial graphite, and the like, but are not particularly limited as long as it may increase conductivity of the positive electrode.

The binder may be for example polyvinylidene fluoride, an ethylene-propylene-diene terpolymer, a styrene-butadiene rubber, an acrylonitrile-rubber, a fluorine rubber, polyvinyl acetate, polymethyl methacrylate, polyethylene, nitrocellulose, and the like, but is not particularly limited as long as it may bind the (positive or negative) active material and the conductive material on the current collector. Examples of the binder may be polyvinyl alcohol, carboxymethyl cellulose (CMC), starch, hydroxypropyl cellulose, recycled cellulose, tetrafluoroethylene, polyethylene, polypropylene, an ethylene-propylene-diene terpolymer (EPDM), sulfonated EPDM, a styrene-butylene rubber, a fluorine rubber, various copolymers, polymeric highly saponified polyvinyl alcohol, and the like, in addition to the foregoing materials.

The negative active material may be, for example, carbon and graphite materials such as natural graphite, artificial graphite, expanded graphite, carbon fiber, non-graphizable carbon, carbon black, carbon nanotube, fullerene, activated carbon, and the like; a metal such as Al, Si, Sn, Ag, Bi, Mg, Zn, In, Ge, Pb, Pd, Pt, Ti, and the like that may be an alloy with lithium and a compound including such an element; a composite material of a metal and a compound thereof and carbon and graphite materials; a lithium-containing nitride, and the like. Among them, carbon-based active materials, silicon-based active materials, tin-based active materials, or silicon-carbon-based active materials may be desirably used and these may be used alone or in a combination of two or more.

The separator is not particularly limited and may be any separator of a rechargeable lithium battery. For example, a porous film or non-woven fabric having excellent high rate discharge performance may be used alone or in a mixture thereof. The separator may include pores, and the pores may have a pore diameter of about 0.01 micrometer (μm) to about 10 μm, and a thickness of about 5 μm to about 300 μm. A substrate of the separator may include, for example, a polyolefin-based resin, a polyester-based resin, polyvinylidene fluoride (PVDF), a vinylidene fluoride-hexafluoropropylene copolymer, a vinylidene fluoride-perfluorovinylether copolymer, a vinylidene fluoride-tetrafluoroethylene copolymer, a vinylidene fluoride-trifluoroethylene copolymer, a vinylidene fluoride-fluoroethylene copolymer, a vinylidene fluoride-hexafluoroacetone copolymer, a vinylidene fluoride-ethylene copolymer, a vinylidene fluoride-propylene copolymer, a vinylidene fluoride-trifluoropropylene copolymer, a vinylidene fluoride-tetrafluoroethylene-hexafluoropropylene copolymer, a vinylidene fluoride-ethylene-tetrafluoroethylene copolymer, and the like. When the electrolyte is a solid electrolyte, such as, for example, a polymer, the solid electrolyte may function as a separator.

The conductive material is a component to further improve conductivity of an active material and may be included in an amount of about 1 weight percent (wt %) to about 30 wt % based on a total weight of the electrode, but is not limited thereto. Such a conductive material is not particularly limited as long as it does not cause chemical changes of a battery and has conductivity, and may be for example, graphite such as natural graphite or artificial graphite; carbon black such as carbon black, acetylene black, ketjen black, channel black, furnace black, lamp black, summer black, and the like; a carbon derivative such as carbon nanotube, fullerene, and the like, a conductive fiber such as a carbon fiber or a metal fiber, and the like; carbon fluoride, a metal powder such as aluminum, a nickel powder, and the like; a conductive whisker such as zinc oxide, potassium titanate, and the like; a conductive metal oxide such as a titanium oxide; a conductive material such as a polyphenylene derivative, and the like.

The filler is an auxiliary component to suppress expansion of an electrode, is not particularly limited as long as it does not cause chemical changes of a battery and is a fiber-shaped material, and may be for example, an olefin-based polymer such as polyethylene, polypropylene, and the like; a fiber-shaped material such as a glass fiber, a carbon fiber, and the like.

In the electrode, the current collector may be a site where electron transports in an electrochemical reaction of the active material and may be a negative current collector and a positive current collector according to types of the electrode. The negative current collector may have a thickness of about 3 μm to about 500 μm. The negative current collector is not particularly limited as long as it does not cause chemical changes of a battery and has conductivity and may be, for example, copper, stainless steel, aluminum, nickel, titanium, fired carbon, copper or stainless steel that is surface-treated with carbon, nickel, titanium, silver, or the like, an aluminum-cadmium alloy, and the like.

The positive current collector may have a thickness of about 3 μm to about 500 μm, but is not limited thereto. Such a positive current collector is not particularly limited as long as it does not cause chemical changes of a battery and has high conductivity and may be, for example, stainless steel, aluminum, nickel, titanium, fired carbon, or aluminum or stainless steel that is surface-treated with carbon, nickel, titanium, silver, or the like.

The current collectors may have a fine concavo-convex form on its surface to reinforce a binding force of the active material and may be used in various shapes of a film, a sheet, a foil, a net, a porous film, a foam, a non-woven fabric, or the like.

The lithium-containing non-aqueous electrolyte solution may include or consist of a non-aqueous electrolyte and a lithium salt.

The non-aqueous electrolyte may be, for example, an aprotic organic solvent such as N-methyl-2-pyrrolidinone, propylene carbonate, ethylene carbonate, butylene carbonate, dimethyl carbonate, diethyl carbonate, gamma-butyrolactone, 1,2-dimethoxy ethane, tetrahydroxy furan, 2-methyl tetrahydrofuran, dimethyl sulfoxide, 1,3-dioxolane, formamide, dimethylformamide, dioxolane, acetonitrile, nitromethane, methyl formate, methyl acetate, phosphoric acid triester, trimethoxy methane, a dioxolane derivative, sulfolane, methyl sulfolane, 1,3-dimethyl-2-imidazolidinone, a propylene carbonate derivative, a tetrahydrofuran derivative, ether, methyl propionate, ethyl propionate, and the like.

The lithium salt is a material that is dissolved in the non-aqueous electrolyte solution and may be, for example, LiCl, LiBr, LiI, LiClO₄, LiBF₄, LiB₁₀Cl₁₀, LiPF₆, LiCF₃SO₃, LiCF₃CO₂, LiAsF₆, LiSbFe, LiAlCl₄, CH₃SO₃Li, CF₃SO₃Li, (CF₃SO₂)₂NLi, lithium chloroborane, lower aliphatic lithium carbonate, lithium tetraphenyl borate, imides, and the like.

An organic solid electrolyte, an inorganic solid electrolyte, and the like may be used as needed.

The organic solid electrolyte may be, for example, a polyethylene derivative, a polyethylene oxide derivative, a polypropylene oxide derivative, a phosphoric acid ester polymer, a poly(L-lysine), a polyester sulfide, polyvinyl alcohol, polyvinylidene fluoride, a polymer including an ionic leaving group, and the like.

The inorganic solid electrolyte may be, for example, nitrides of Li such as Li₃N, LiI, Li₅NI₂, Li₃N—LiI—LiOH, LiSiO₄, LiSiO₄—LiI—LiOH, Li₂SiS₃, Li₄SiO₄, Li₄SiO₄—LiI—LiOH, Li₃PO₄—Li₂S—SiS₂, and the like, halides, sulfates, and the like.

The non-aqueous electrolyte solution may include, for example, pyridine, triethylphosphite, triethanolamine, cyclic ether, ethylene diamine, n-glyme, hexaphosphoric triamide, a nitrobenzene derivative, sulfur, a quinone imine dye, N-substituted oxazolidinone, N,N-substituted imidazolidine, ethylene glycol dialkyl ether, an ammonium salt, pyrrole, 2-methoxy ethanol, or aluminum trichloride in order to improve charge and discharge characteristics, flame retardancy, and the like. As needed, in order to provide inflammability, a halogen-containing solvent such as carbon tetrachloride, ethylene trifluoride, and the like may be further added, and in order to improve high temperature storage characteristics, carbon dioxide gas may be further added.

As described above, a battery module including a battery case according to an embodiment does not need manufacture of a unit cell including exterior materials consisting of additional moisture transmission resistance materials on each electrode assembly, and thus an electrode assembly accommodated in the battery case container or in each cell compartment in the container does not need additional exterior materials.

Hereinafter, the embodiments are described with reference to examples and comparative examples. The following examples and comparative examples are exemplary but do not limit the scope of the present disclosure.

### EXAMPLES

### Example 1: Preparation of Liquid Crystal Aromatic Polymer Including Aliphatic Organic Group

77.61 g of 4-hydroxybenzoic acid (HBA), 39.11 g of 6-hydroxy-2-naphthoic acid (HNA), 3.125 g of decanol, and 84.23 g of acetic anhydride are added to a 200 ml glass reactor equipped with a torque meter, a thermometer, and a reflux condenser to assemble a reactor, and heated up to 140° C. at 150 rpm for 30 minutes, and maintained at that temperature for one hour. Then, the reflux condenser is replaced with a dean-stark condenser, the temperature is slowly increased up to 320° C. over 2 hours, and 50 mg of TiOBu₄ is added the glass reactor at 280° C. When the temperature reaches 320° C., the agitation speed is decreased down to 60 rpm, and when an agitation torque becomes 0.4 A, a reaction is stopped to collect a polymerization product.

### Example 2: Preparation of Liquid Crystal Aromatic Polymer Including Aliphatic Organic Group

A reaction is performed in the same manner as in Example 1, except that 75.62 g of 4-hydroxybenzoic acid (HBA), 38.11 g of 6-hydroxy-2-naphthoic acid (HNA), 6.25 g of decanol, and 84.23 g of acetic anhydride are added to a 200 ml glass reactor equipped with a torque meter, a thermometer, and a reflux condenser.

### Example 3: Preparation of Liquid Crystal Aromatic Polymer Including Aliphatic Organic Group

A reaction is performed in the same manner as in Example 1, except that 73.63 g of 4-hydroxybenzoic acid (HBA), 37.11 g of 6-hydroxy-2-naphthoic acid (HNA), 9.375 g of decanol, and 84.23 g of acetic anhydride are added to a 200 ml glass reactor equipped with a torque meter, a thermometer, and a reflux condenser.

### Example 4: Preparation of Liquid Crystal Aromatic Polymer Including Aliphatic Organic Group

A reaction is performed in the same manner as in Example 1, except that 72.6 g of 4-hydroxybenzoic acid (HBA), 36.6 g of 6-hydroxy-2-naphthoic acid (HNA), 12.6 g of decanol, and 86.5 g of acetic anhydride are added to a 200 ml glass reactor equipped with a torque meter, a thermometer, and a reflux condenser.

### Example 5: Preparation of Liquid Crystal Aromatic Polymer Including Aliphatic Organic Group

A reaction is performed in the same manner as in Example 1, except that 75.62 g of 4-hydroxybenzoic acid (HBA), 38.11 g of 6-hydroxy-2-naphthoic acid (HNA), 9.16 g of 2,2,3,3,4,4,5,5-octafluoro-1-pentenol, and 84.23 g of acetic anhydride are added to a 200 ml glass reactor equipped with a torque meter, a thermometer, and a reflux condenser.

### Comparative Example 1: Preparation of Liquid Crystal Aromatic Polymer

A reaction is performed in the same manner as in Example 1, except that 73.0 g of 4-hydroxybenzoic acid (HBA), 36.79 g of 6-hydroxy-2-naphthoic acid (HNA), and 84.23 g of acetic anhydride are added to a 200 ml glass reactor equipped with a torque meter, a thermometer, and a reflux condenser.

### Comparative Example 2: Preparation of Liquid Crystal Aromatic Polymer

A reaction is performed in the same manner as in Example 1, except that 75.62 g of 4-hydroxybenzoic acid (HBA), 38.11 g of 6-hydroxy-2-naphthoic acid (HNA), 6.8 g of decanoic acid, and 84.23 g of acetic anhydride are added to a 200 ml glass reactor equipped with a torque meter, a thermometer, and a reflux condenser.

### Comparative Example 3: Preparation of Liquid Crystal Aromatic Polymer

A reaction is performed in the same manner as in Example 1, except that 75.62 g of 4-hydroxybenzoic acid (HBA), 38.11 g of 6-hydroxy-2-naphthoic acid (HNA), 3.5 g of butanediol, and 84.23 g of acetic anhydride are added to a 200 ml glass reactor equipped with a torque meter, a thermometer, and a reflux condenser.

### Evaluation

Compositions and inherent viscosity of the liquid crystal aromatic polymers according to Examples 1 to 5 and Comparative Examples 1 to 3, and a water vapor transmission rate (WVTR) and impact strength of articles injection-molded from the liquid crystal aromatic polymers are measured, and the results are shown in Table 1.

First, 20 milligrams (mg) of each polymerization product prepared in the Examples and Comparative Examples is taken and dissolved in 10 milliliters (ml) of pentafluorophenol at 99° C. 10 ml of chloroform is added thereto, and inherent viscosity of each liquid crystal aromatic polymer is measured at 30° C.

In addition, the liquid crystal aromatic polymers according to the Examples and Comparative Examples are respectively ground to have a length of less than or equal to about 1 cm, mixed in an extruder heated at 280° C. and having two-screw axes rotating in the same direction. The extruded mixture is injection-molded at 310° C. to manufacture disk-shaped articles having a thickness of about 1 millimeter (mm) and a diameter of 30 mm, and a water vapor transmission rate and impact strength of each article are measured. The water vapor transmission rate and the impact strength are specifically measured by the following method.

(1) Water Vapor Transmission Rate (WVTR): Water Vapor Transmission Rate is measured according to ISO15106, F1249 by using an Aquatran equipment (Mocon Inc.) at 38° C. under relative humidity of 100%.

(2) Impact Strength: Un-notched type Izod impact strength is measured according to ASTM D265 by using an impactor II, CEAST 9050 made by Instron Corp.

TABLE 1

| | Aromatic | | | Disk-shaped Article | | |
|---|---|---|---|---|---|---|
| | monomer | | Aliphatic | Inherent | Impact | WVTR |
| | (mol %) | | compound | viscosity | strength | (g/m²/ |
| | HBA | HNA | (mol %)* | (dl/g) | (KJ/m²) | day) |
| Example 1 | 73 | 27 | 2.5 | 8.5 | 67.7 | 0.0064 |
| Example 2 | 73 | 27 | 5.0 | 8.9 | 92.4 | 0.0056 |
| Example 3 | 73 | 27 | 7.5 | 5.8 | 114.3 | 0.0083 |
| Example 4 | 73 | 27 | 10.0 | 4.7 | 42.8 | — |
| Example 5 | 73 | 27 | 5.0 | 6.6 | 42.7 | 0.0221 |
| Comparative | 73 | 27 | 0 | 8.5 | 14.2 | 0.076 |
| Example 1 | | | | | | |
| Comparative | 73 | 27 | 5.0 | 7.6 | 16.4 | 0.0266 |
| Example 2 | | | | | | |
| Comparative | 73 | 27 | 5.0 | — | unmea- | — |
| Example 3 | | | | | surable | |

*The aliphatic compound in Examples 1-5 is decanol, the aliphatic compound in Comparative Example 2 is decanoic acid, and the aliphatic compound in Comparative Example 3 is butanediol.

by copolymerizing liquid crystal aromatic monomers, the articles of Examples 1 to 5 including the liquid crystal aromatic polymer prepared by adding an aliphatic compound, and particularly, an aliphatic compound having a functional group capable of forming an ester bond with a carboxyl group of the liquid crystal aromatic monomers, that is, an aliphatic compound having a hydroxy group at one terminal end from the beginning of a reaction exhibit greatly increased impact strength of greater than 40 kiloJoules per square meter (KJ/m²) compared with the article of Comparative Example 1 including a liquid crystal aromatic polymer not including the aliphatic compound but formed of an aromatic monomer. As an amount of the aliphatic compound is increased, impact strength tends to increase, but when 10 mol % of decanol is included, impact strength tends to decrease again.

On the other hand, Comparative Example 2 including decanoic acid instead of the decanol as an aliphatic compound exhibits almost not increased impact strength compared with Comparative Example 1, even though a carboxyl group of the decanoic acid has an ester bond with a hydroxy group of HBA or HNA. The reason may be that the decanoic acid, unlike the decanol, is chemically unstable and all decomposed, as a temperature is increased during polymerization of liquid crystal monomers into a liquid crystal polymer, and thus may not substantially form an ester bond with the liquid crystal aromatic monomers.

The liquid crystal polymer of Comparative Example 3 is too brittle to measure impact strength. In other words, butanediol including two hydroxy groups, unlike the decanol including one hydroxy group, has an ester bond in both directions with liquid crystal monomers, and thus hinders the liquid crystal monomers from growing into a liquid crystal polymer.

Furthermore, the articles according to Examples 1 to 5 exhibit greatly improved moisture transmission resistivity compared with the article including no aliphatic compound according to Comparative Example 1.

Accordingly, an article manufactured by using a liquid crystal aromatic polymer including an aliphatic organic group at one terminal end according to an embodiment simultaneously realizes high moisture transmission resistivity and mechanical properties, and thus may be advantageously used for a case for a rechargeable battery, and a battery module, and the like.

While this disclosure has been described in connection with what is presently considered to be practical embodiments, it is to be understood that the invention is not limited to the disclosed embodiments, but, on the contrary, is intended to cover various modifications and equivalent arrangements included within the spirit and scope of the appended claims.

What is claimed is:

1. A battery case comprising;
a container configured to accommodate an electrode assembly,
wherein the container comprises a bottom wall and a plurality of side walls, the bottom wall and the plurality of side walls are integrated to have an open side opposed to the bottom wall and to provide a space for accommodating the electrode assembly, wherein
at least one of the bottom wall or the plurality of side walls comprises a liquid crystal aromatic polymer,
at least a portion of the liquid crystal aromatic polymer comprises an aliphatic organic group at one terminal end, and
the battery case has a water vapor transmittance rate at a thickness of about 1 millimeter according to ISO 15106 or ASTM F1249 at 38° C. and a relative humidity of 100% of less than about 0.07 grams per square meter per day and an impact strength according to ASTM D265 of greater than or equal to about 20 kiloJoules per square meter.

2. The battery case of claim 1, wherein the liquid crystal aromatic polymer comprises liquid crystal aromatic polyester, liquid crystal aromatic polyamide, liquid crystal aromatic polyesteramide, or a combination thereof.

3. The battery case of claim 1, wherein the aliphatic organic group is a substituted or unsubstituted C1 to C100 saturated or unsaturated aliphatic hydrocarbon group.

4. The battery case of claim 1, wherein the liquid crystal aromatic polymer comprises a liquid crystal aromatic polyester, and at least a portion of the liquid crystal aromatic polyester comprises a substituted or unsubstituted C1 to C20 saturated or unsaturated aliphatic hydrocarbon group linked through an ester bond at one terminal end.

5. The battery case of claim 1, wherein the liquid crystal aromatic polymer comprises a liquid crystal aromatic polyamide, and at least a portion of the liquid crystal aromatic polyamide comprises a substituted or unsubstituted C1 to C20 saturated or unsaturated aliphatic hydrocarbon group linked through an amide bond at one terminal end.

6. The battery case of claim 5, wherein the liquid crystal aromatic polymer comprises a liquid crystal aromatic polyester amide, and at least a portion of the liquid crystal aromatic polyester amide comprises a substituted or unsubstituted C1 to C20 saturated or unsaturated aliphatic hydrocarbon group linked through an amide bond or an ester bond at one terminal end.

7. The battery case of claim 1, wherein the liquid crystal aromatic polymer comprises: a structural unit represented by Chemical Formula 1, and/or a structural unit represented by Chemical Formula 2 and a structural unit represented by Chemical Formula 3:
*—(—(C═O)—Ar¹—O—)—* Chemical Formula 1
*—(—(C═O)—Ar²—(C═O)—)—* Chemical Formula 2
*—(—O—Ar³—O—)—* Chemical Formula 3
wherein, in Chemical Formulae 1 to 3,
Ar², and Ar³ are each independently a group comprising a single substituted or unsubstituted C6 to C30 aromatic ring group, a condensed ring of two or more substituted or unsubstituted C6 to C30 aromatic ring groups, or a group comprising two or more substituted or unsubstituted C6 to C30 aromatic ring groups that are linked by a single bond, —O—, —C(═O)—, —C(OH)₂—, —S—, —S(O)₂—.

8. The battery case of claim 1, wherein the liquid crystal aromatic polymer comprises a structural unit represented by Chemical Formula 4, and/or a structural unit represented by Chemical Formula 5 and a structural unit represented by Chemical Formula 2:
*—(—(C═O)—Ar⁴—NH—)—* Chemical Formula 4
*—(—NH—Ar⁴—NH—)—* Chemical Formula 5
*—(—(C═O)—Ar²—(C═O)—)—* Chemical Formula 2
wherein, in Chemical Formula 4, Chemical Formula 5, and Chemical Formula 2,
Ar⁴, Ar⁵, and Ar² are each independently a group comprising a single substituted or unsubstituted C6 to C30 aromatic ring group, a condensed ring of two or more substituted or unsubstituted C6 to C30 aromatic ring groups, or a group comprising two or more substituted or unsubstituted C6 to C30 aromatic ring groups that are linked by a single bond, —O—, —C(═O)—, —C(OH)₂—, —S—, or —S(O)₂—.

9. The battery case of claim 1, wherein the liquid crystal aromatic polymer comprises
(1) (i) a structural unit represented by Chemical Formula 1, and/or a structural unit represented by Chemical Formula 2 and a structural unit represented by Chemical Formula 3, and (ii) a structural unit represented by Chemical Formula 4, and/or a structural unit represented by Chemical Formula 2 and a structural unit represented by Chemical Formula 5, and/or
(2) a structural unit represented by Chemical Formula 6 and a structural unit represented by Chemical Formula 2:
*—(—(C═O)—Ar¹—O—)—* Chemical Formula 1
*—(—(C═O)—Ar²—(C═O)—)—* Chemical Formula 2
*—(—O—Ar³—O—)—* Chemical Formula 3
*—(—(C═O)—Ar⁴—NH—)—* Chemical Formula 4
*—(—NH—Ar⁵—NH—)—* Chemical Formula 5
*—(—NH—Ar⁶—O—)—* Chemical Formula 6
wherein, in Chemical Formulae 1 to 6,
Ar¹, Ar², Ar³, Ar⁴, Ar⁵, and Ar⁶ are each independently a group comprising a single substituted or unsubstituted C6 to C30 aromatic ring group, a condensed ring of two or more substituted or unsubstituted C6 to C30 aromatic ring groups, or a group comprising two or more substituted or unsubstituted C6 to C30 aromatic ring groups that are linked by a single bond, —O—, —C(═O)—, —C(OH)₂—, —S—, or —S(O)₂—.

10. The battery case of claim 7, wherein the structural unit represented by Chemical Formula 1 is derived from p-hydroxybenzoic acid, 6-hydroxy-2-naphthoic acid, or a combination thereof.

11. The battery case of claim 7, wherein the structural unit represented by Chemical Formula 2 is derived from terephthalic acid, isophthalic acid, naphthalene dicarboxylic acid, or a combination thereof, and the structural unit represented by Chemical Formula 3 is derived from hydroquinone, 4,4′-dihydroxybiphenyl, or a combination thereof.

12. The battery case of claim 8, wherein the structural unit represented by Chemical Formula 4 is derived from 4-aminobenzoic acid, 2-amino-naphthalene-6-carboxylic acid, 4-aminobiphenyl-4-carboxylic acid, or a combination thereof.

13. The battery case of claim 8, wherein the structural unit represented by Chemical Formula 5 is derived from 1,4-phenylene diamine, 1,3-phenylene diamine, 2,6-naphthalene diamine, or a combination thereof, and the structural unit represented by Chemical Formula 2 is derived from terephthalic acid, isophthalic acid, naphthalene dicarboxylic acid, or a combination thereof.

14. The battery case of claim 9, wherein the structural unit represented by Chemical Formula 6 is derived from 3-aminophenol, 4-aminophenol, 2-amino-6-naphthol, or a combination thereof, and the structural unit represented by Chemical Formula 2 is derived from terephthalic acid, isophthalic acid, naphthalene dicarboxylic acid, or a combination thereof.

15. The battery case of claim 1, wherein the liquid crystal aromatic polymer is a copolymer of about 60 mole percent to about 80 mole percent of p-hydroxybenzoic acid, about 20 mole percent to about 40 mole percent of 6-hydroxy-2-naphthoic acid, and less than or equal to about 20 mole percent of a substituted or unsubstituted C1 to C20 monohydroxy alkane based on a total moles of the p-hydroxybenzoic acid and 6-hydroxy-2-naphthoic acid.

16. The battery case of claim 1, wherein the battery case further comprises a lid configured to cover at least a portion of the open side of the container and having at least one of a positive terminal or a negative terminal.

17. The battery case of claim 16, wherein the lid comprises a liquid crystal aromatic polymer, wherein at least a portion of the liquid crystal aromatic polymer has a substituted or unsubstituted aliphatic hydrocarbon group at one terminal end.

18. The battery case of claim 1, wherein the container of the battery case comprises a plurality of cell compartments separated by at least one partition wall disposed in the space.

19. A battery comprising
the battery case of claim 1, and
an electrode assembly comprising a positive electrode and a negative electrode accommodated in the container of the battery case.

20. A battery module comprising
the battery case of claim 18, and
a plurality of electrode assemblies comprising a positive electrode and a negative electrode accommodated in each of the plurality of cell compartments of the battery case.
